(19) United States
(12) Patent Application Publication
(10) Pub. No.: US 2025/0217698 A1
(43) Pub. Date: Jul. 3, 2025

(54) AUTOMATED CONTROL FOR A PHYSICAL SYSTEM WITH GENERIC FORECASTING MODELS

(71) Applicant: International Business Machines Corporation, Armonk, NY (US)

(72) Inventors: Dung Tien Phan, PLEASANTVILLE, NY (US); Sumanta Mukherjee, Bangalore (IN); Pankaj Satyanarayan Dayama, Bangalore (IN); Jayant R. Kalagnanam, Briarcliff Manor, NY (US)

(21) Appl. No.: 18/403,095

(22) Filed: Jan. 3, 2024

(51) Int. Cl. G06N 20/00

(52) U.S. Cl. CPC G06N 20/00

(57) ABSTRACT

One or more systems, devices, computer program products and/or computer-implemented methods of use provided herein relate to automated control for a physical system with generic forecasting models. The computer-implemented system can comprise a memory that can store computer executable components. The computer-implemented system can further comprise a processor that can execute the computer executable components stored in the memory, wherein the computer executable components can comprise a training component that trains one or more multivariate time series forecasting models, and a prediction component that forecasts long-horizon action trajectories for a set of state variables over a defined range of time. Furthermore, an analysis component can linearize the state-based action response model, wherein the linearized the state-based action response model can be formulated into an MILP optimization problem and solved to obtain a multi-step set-point recommendation.

### BACKGROUND

The subject disclosure relates to process control and, more specifically, to automated control for a physical system with generic forecasting models.

### SUMMARY

The following presents a summary to provide a basic understanding of one or more embodiments described herein. This summary is not intended to identify key or critical elements, delineate scope of particular embodiments or scope of claims. Its sole purpose is to present concepts in a simplified form as a prelude to the more detailed description that is presented later. In one or more embodiments described herein, systems, computer-implemented methods, apparatus and/or computer program products that enable automated control for a physical system with generic forecasting models.

According to an embodiment, a computer-implemented system is provided. The computer-implemented system can comprise a memory that can store computer executable components. The computer-implemented system can further comprise a processor that can execute the computer executable components stored in the memory, wherein the computer executable components can comprise a training component that trains one or more multivariate time series forecasting models; and a prediction component that forecasts long-horizon action trajectories for a set of state variables over a defined range of time.

According to another embodiment, a computer-implemented method is provided. The computer-implemented method can comprise training, by a system operatively coupled to a processor, one or more multivariate time series forecasting models; and forecasting, by the system, long-horizon action trajectories for a set of state variables over a defined range of time. According to yet another embodiment, a computer program product for facilitating automated control for a physical system with generic forecasting models is provided. The computer program product can comprise a computer readable storage medium having program instructions embodied therewith, the program instructions executable by a processor to cause the processor to train one or more multivariate time series forecasting models; and forecast long-horizon action trajectories for a set of state variables over a defined range of time.

### BRIEF DESCRIPTION OF THE DRAWINGS

One or more embodiments are described below in the Detailed Description section with reference to the following drawings:

FIG. 1 illustrates a block diagram of an example, non-limiting system that can facilitate automated control for a physical system with generic forecasting models in accordance with one or more embodiments described herein.

FIG. 2 illustrates an example, non-limiting representation of process control of a physical system in accordance with one or more embodiments described herein.

FIG. 3 illustrates an example, non-limiting representation of inputs and outputs of a physical system in accordance with one or more embodiments described herein.

FIG. 4 illustrates an example, non-limiting representation of process set-point recommendation in accordance with one or more embodiments described herein.

FIG. 5 illustrates an example, non-limiting representation of decision optimization pipelines in accordance with one or more embodiments described herein.

FIG. 6 illustrates an example, non-limiting representation of model setup for multivariate time series forecasting model training in accordance with one or more embodiments described herein.

FIG. 7 illustrates an example, non-limiting representation of approximating forecasting models in accordance with one or more embodiments described herein.

FIG. 8 illustrates an example, non-limiting representation of approximating forecasting models in accordance with one or more embodiments described herein.

FIG. 9 illustrates an example, non-limiting representation of an optimization model for set-point recommendation in accordance with one or more embodiments described herein.

FIG. 10 illustrates an example, non-limiting representation of reformulation to mixed-integer linear programming in accordance with one or more embodiments described herein.

FIG. 11 illustrates an example, non-limiting representation of system architecture that can facilitate automated control for a physical system with generic forecasting models in accordance with one or more embodiments described herein.

FIG. 12 illustrates a flow diagram of an example, non-limiting method 1200 of facilitating automated control for a physical system with generic forecasting models in accordance with one or more embodiments described herein.

FIG. 13 illustrates a block diagram of an example, non-limiting operating environment in which one or more embodiments described herein can be facilitated.

### DETAILED DESCRIPTION

The following detailed description is merely illustrative and is not intended to limit embodiments and/or application or uses of embodiments. Furthermore, there is no intention to be bound by any expressed or implied information presented in the preceding Background or Summary sections, or in the Detailed Description section.

One or more embodiments are now described with reference to the drawings, wherein like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

Plant or industrial processes (e.g., metal production, mining, electronic device assembly, concreate production) are processes that are monitored by a multitude of sensors to collect data that can be used to optimize process control or key performance indicators (KPI). For example, process plant operations are frequently run with an objective to minimize energy and/or maximize yield. These process plants are often equipped with Internet of Things (IoT) devices for process monitoring, generating large volumes of data which make it amenable to apply data driven solutions to obtain set-point recommendations. Plants are generally operated under controlled conditions. Control (e.g., action) variables are aspects of such process that can be controlled by a process operator (e.g., amount of material used, gas flow rates, pressure levels). State variables are aspects of equipment or a process that are not directly controlled and results from a set of control variables.

However, current methods of process optimization face various challenges.

First, systems for process control may contain significant inertia, meaning a response to any action variable change can occur after a long duration (e.g. 5-6 hours in the case of a Blast furnace). Current methods do not model such systems as a long horizon forecasting problem to manage the inertia and long-horizon trajectory optimization. Furthermore, multi-variate forecasting models are often large, containing millions or billions of parameters. These models produce a very complex function space. Thus, optimizing on such non-linear parameter spaces while maintaining a long horizon forecast trajectory within a desirable range is challenging. Many approaches address the issue of single point prediction by model linearization. However, linearizing models comprising millions of parameters is intensive and often not feasible.

Second, current approaches are unable to support model linearization for a general class of artificial intelligence (AI) and multi-variate timeseries forecasting models while integrating optimization formulation. Such approaches provide model linearization only for a restricted class of AI models (e.g., Decision tree, Random Forest, MARS, ReLU DNN, RNN models).

Third, optimization formulation for the restricted AI models comprises single-step mixed-integer linear formulation (MILP), meaning that from a current time, a single step is predicted and formulated as an optimization problem. Current methods are unable to support optimization problems with multi-step recommendations. Such methods may require continuous updating of optimization formulation and can involve adjusting numerous parameters or constraints due to the complexities of process control, and thus may be infeasible to implement. Additionally, conventional approaches assume set-points (e.g., control variables) between prediction models are independent, and therefore cannot account for correlated control variables.

Accordingly, systems or techniques that can address one or more of these technical problems can be desirable.

Various embodiments described herein can address one or more of these technical problems. One or more embodiments described herein can include systems, computer-implemented methods, apparatus, or computer program products that can facilitate automated control for a physical system with generic forecasting models. That is, various disadvantages associated with existing techniques for process control can be ameliorated by automated control for a physical system with generic forecasting models.

In various embodiments, a training component can train one or more multivariate time series forecasting models. In various aspects, a prediction component can forecast long-horizon action trajectories for a set of state variables over a defined range of time. Thus, a state-based action response model can be used to approximate the one or more multivariate time series forecasting models. Furthermore, an analysis component can linearize the state-based action response model, which can be reformulated into an optimization problem. Moreover, the state-based action response model can be reformulated as a mixed-integer linear program (MILP). MILP is a mathematical modeling approach to solve optimization tasks where the objective is to minimize or maximize a linear function subject to linear constraints, and wherein some decision variables can be restricted to integer values. After reformulation to MILP, the optimization problem can be solved for a set point recommendation, enabling process optimization to be automated, obtain multi-step set-point recommendations, and provide long-horizon trajectory optimization.

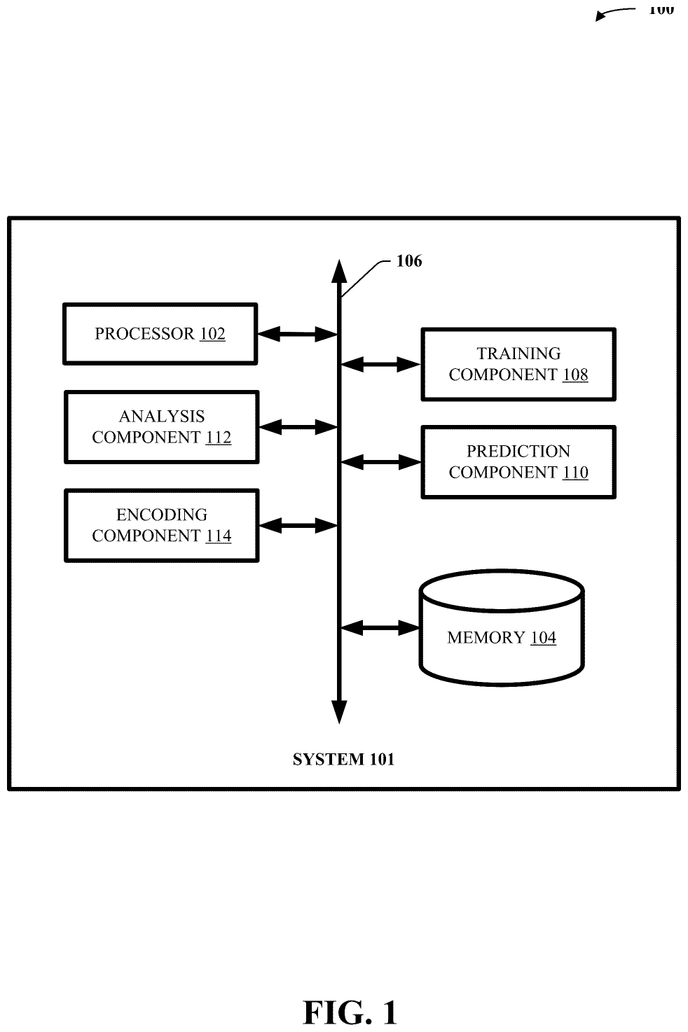

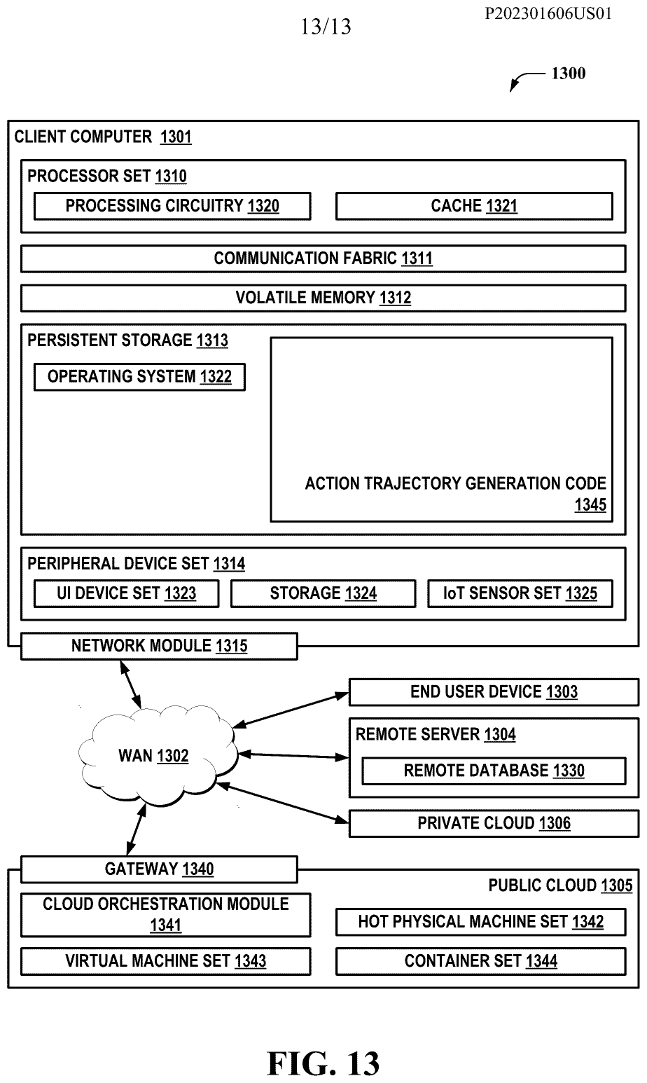

The embodiments depicted in one or more figures described herein are for illustration only, and as such, the architecture of embodiments is not limited to the systems, devices and/or components depicted therein, nor to any particular order, connection and/or coupling of systems, devices and/or components depicted therein. For example, in one or more embodiments, the non-limiting systems described herein, such as non-limiting system 100 as illustrated at FIG. 1, and/or systems thereof, can further comprise, be associated with and/or be coupled to one or more computer and/or computing-based elements described herein with reference to an operating environment, such as the operating environment 1300 illustrated in FIG. 13. For example, system 100 can be associated with, such as accessible via, a computing environment 1300 described below with reference to FIG. 13, such that aspects of processing can be distributed between system 100 and the computing environment 1300. In one or more described embodiments, computer and/or computing-based elements can be used in connection with implementing one or more of the systems, devices, components and/or computer-implemented operations shown and/or described in connection with FIG. 1 and/or with other figures described herein.

FIG. 1 illustrates a block diagram of an example, non-limiting system 100 that can facilitate automated control for a physical system with generic forecasting models in accordance with one or more embodiments described herein. System 100 can comprise processor 102, memory 104, system bus 106, training component 108, prediction component 110, analysis component 112, and encoding component 114.

The system 100 and/or the components of the system 100 can be employed to use hardware and/or software to solve problems that are highly technical in nature (e.g., forecast model training, model linearization, optimization formulation of forecasting models, etc.), that are not abstract and that cannot be performed as a set of mental acts by a human. Further, some of the processes performed may be performed by specialized computers for carrying out defined tasks related to automated control for a physical system with generic forecasting models. The system 100 and/or components of the system can be employed to solve new problems that arise through advancements in technology, computer networks, the Internet and the like. The system 100 can provide technical improvements to generating multi-step set point recommendations, long horizon trajectory optimization, and/or automation of process control, etc.

Discussion turns briefly to processor 102, memory 104 and bus 106 of system 100. For example, in one or more embodiments, the system 100 can comprise processor 102 (e.g., computer processing unit, microprocessor, classical processor, and/or like processor). In one or more embodiments, a component associated with system 100, as described herein with or without reference to the one or more figures of the one or more embodiments, can comprise one or more computer and/or machine readable, writable and/or executable components and/or instructions that can be executed by processor 102 to enable performance of one or more processes defined by such component(s) and/or instruction(s).

In one or more embodiments, system 100 can comprise a computer-readable memory (e.g., memory 104) that can be operably connected to the processor 102. Memory 104 can store computer-executable instructions that, upon execution by processor 102, can cause processor 102 and/or one or more other components of system 100 (e.g., training component 108, prediction component 110, analysis component 112, and/or encoding component 114) to perform one or more actions. In one or more embodiments, memory 104 can store computer-executable components (e.g., training component 108, prediction component 110, analysis component 112, and/or encoding component 114).

System 100 and/or a component thereof as described herein, can be communicatively, electrically, operatively, optically and/or otherwise coupled to one another via bus 106. Bus 106 can comprise one or more of a memory bus, memory controller, peripheral bus, external bus, local bus, and/or another type of bus that can employ one or more bus architectures. One or more of these examples of bus 106 can be employed. In one or more embodiments, system 100 can be coupled (e.g., communicatively, electrically, operatively, optically and/or like function) to one or more external systems (e.g., a non-illustrated electrical output production system, one or more output targets, an output target controller and/or the like), sources and/or devices (e.g., classical computing devices, communication devices and/or like devices), such as via a network. In one or more embodiments, one or more of the components of system 100 can reside in the cloud, and/or can reside locally in a local computing environment (e.g., at a specified location(s)).

In addition to the processor 102 and/or memory 104 described above, system 100 can comprise one or more computer and/or machine readable, writable and/or executable components and/or instructions that, when executed by processor 102, can enable performance of one or more operations defined by such component(s) and/or instruction(s). For example, the training component 108 can train a multivariate time series forecasting model. Thus, the training component 108 can approximate the forecasting model with a state-based action response model. Additional aspects of the one or more embodiments discussed herein are explained in greater detail with reference to subsequent figures. System 100 can be associated with, such as accessible via, a computing environment 1300 described below with reference to FIG. 13. For example, system 100 can be associated with a computing environment 1300 such that aspects of processing can be distributed between system 100 and the computing environment 1300.

In various embodiments, the training component 108 can train one or more multivariate time series forecasting models. In various aspects, an individual forecasting model can be trained for each KPI of a process (e.g., raw material utilization, slag generation, or hot metal temperature of a blast furnace). Furthermore, forecasting models can be included for various constraints, as well as objectives, of the process. The training component 108 can train the one or more forecasting models with historical data for the physical system. The historical data can be obtained using tabular and time series data of the physical system.

In various embodiments, the prediction component 110 can forecast long-horizon action trajectories for a set of state variables over a defined range of time. For example, the action trajectories can comprise a long horizon wherein the time range extends to a distant future or desirable range (e.g., 2 months, 3 weeks, 6 hours). Therefore, action trajectories can be predicted for state variables that need to be maintained within a desirable operating range. Moreover, long-horizon action trajectories enable the response to control variables to handle inertia of a system as selected control set-points can have long-horizon impact on state variables.

In various aspects, the training component 108 can simulate action trajectories to obtain a response from a global forecasting model. Thus, the response from the global forecasting model can be used as a target trajectory to train a state-based action response model. In various embodiments, the state-based action response model can approximate the forecasting model. More specifically, the forecasting model F at time/behaves uniquely to a subjected action given a current trajectory, as defined by the following equation: F({zₜ₊₁, zₜ₊₂, . . . z_{T}}|{x₁, x₂, . . . xₜ; z₁, z₂, . . . zₜ})={xₜ₊₁, xₜ₊₂, . . . x_{T}}, where x represents state variables of a physical system and z represents controlled variables of the physical system. The forecasting model F predicts state variables for next (T−t) time periods (xₜ₊₁, xₜ₊₂, . . . z_{T}) for candidate controlled variables (zₜ₊₁, zₜ₊₂, . . . z_{T}). The unique response to the subjected action allows the state-based action response model to be fitted to the global complex forecasting model. In other words, the state-based action response model approximates the model response locally given the specific trajectory. The state-based action response model S is typically a function approximation model that produces approximate response interpolation given an action trajectory (zₜ₊₁, zₜ₊₂, . . . z_{T}), and can be defined by the following equation: S(zₜ₊₁, zₜ₊₂, . . . z_{T})≈F({zₜ₊₁, zₜ₊₂, . . . z_{T}}|{x₁, x₂, . . . xₜ; z₁, z₂, . . . zₜ}). Furthermore, the state-based action response model assumes the state context is fixed. Moreover, in contrast to the global complex forecasting model, the state-based action response model is easily linearizable, enabling further optimization processes feasible. The state-based action response model can be, but is not limited to, a multilayer perceptron (i.e., a type of artificial neural network architecture that is feedforward and comprises multiple layers of interconnected nodes or artificial neurons), a Random Forest (i.e., an ensemble learning method that operates by constructing a multitude of decision trees during training and outputs the class that is the mode of the classes or the mean prediction of the individual trees), or a recurrent neural network (i.e., a type of artificial neural network designed for processing sequential data or data with temporal dependencies where connections form directed cycles).

In various aspects, after the long-horizon multivariate time series forecasting models are trained, at the current time t the following steps described herein can be performed for t+1 to T, wherein T represents a scheduling horizon. In various embodiments, the training component 108 can obtain historical data, current state data, and current action data, denoted by {x_{t-w}, x_{t-w+1}, . . . xₜ; z_{t-w}, z_{t-w+1}, . . . zₜ}, where w is the time window to capture the inertia of the system. Thus, the prediction component 110 can sample actions {zₜ₊₁, . . . z_{T}} by applying a sampling method starting from the current trajectory (e.g., a stair method wherein a series of samples are tested sequentially to determine a median value of a fatigue limit). The training component 108 can then generate sampled target variables {rₜ₊₁, . . . r_{T}} with the long-horizon multivariate forecasting model using the sampled actions and history trajectory. Therefore, the analysis component 112 can fit the sampled actions and sampled target variables

$${\{ {z}_{t + 1}^{i} , … , {z}_{t + T}^{i} , {r}_{t + 1}^{i} , … , {r}_{T}^{i} \}}_{i = 1}^{N}$$

to the forecasting model by a piece-wise linear regressor such as Random Forest, multilayer perceptron, or recurrent neural network for each type of target variable to obtain the state-based action response model. In various embodiments, the analysis component 112 can then linearize the state-based action response model to allow a globally optimal solution to be obtained efficiently. Furthermore, the encoding component 114 can reformulate the state-based action response model as a MILP, wherein business requirements or constraints can be included in formulation. From the MILP formulation, the analysis component 112 can solve the optimization problem to obtain a set-point recommendation for time periods t+1, . . . , T. In various aspects, a set-point recommendation can be obtained for each time from t+1 to T, producing multi-step set-point recommendations for a physical system over the scheduling horizon.

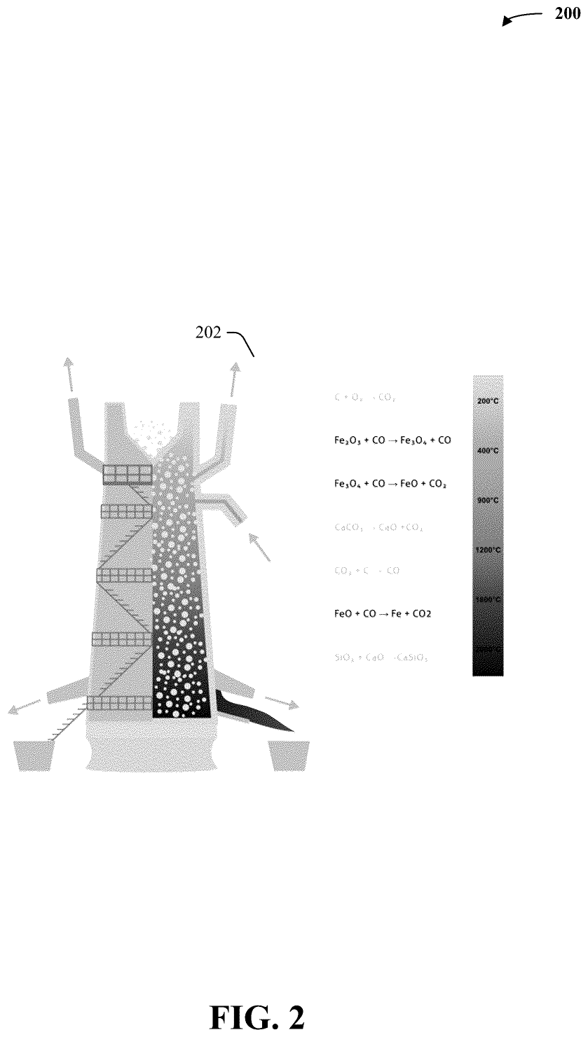

FIG. 2 illustrates an example, non-limiting representation of process control of a physical system in accordance with one or more embodiments described herein.

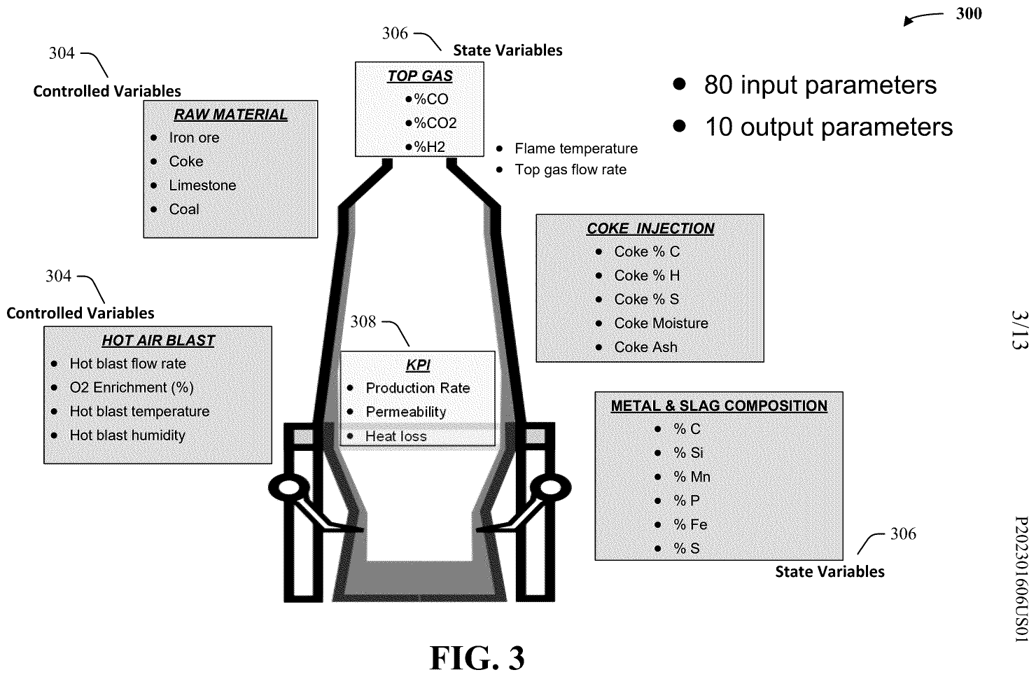

As depicted in 202, an example physical system can be a blast furnace, wherein a goal for process control can be to operate the blast furnace with maximum efficiency. To achieve the objective for efficiency, a set of set-points can be controlled. More specifically, a set of parameters can be determined to maximize throughput of a physical system (e.g., control and determine a temperature of the blast furnace that enables maximum efficiency). However, there may be requirements for parameters to be controlled such that they comply with regulations or constraints. For example, parameters can be monitored and controlled to abide to various safety regulations (e.g., maximum temperature of a blast furnace) or there may be various KPI constraints. An example physical system 300 of a blast furnace can be illustrated by FIG. 3. The physical system 300 can comprise 80 input parameters, 10 output parameters (e.g., instant production rate, thermal indicator, blast loss, top gas flow rate, flame temperature), and KPIs 308 (e.g., production rate, permeability, heat loss). Furthermore, the physical system 300 can be monitored with control variables 304 (e.g., iron ore, coal consumption, hot blast flow rate) and state variables 306 (e.g., % CO, % H2, % Fe, % Si). The methods described herein can enable automated optimized control of such physical systems (e.g., physical system 300) through a combination of multivariate time series forecasting and optimization techniques in a unified framework. Furthermore, the methods described herein are data-driven, meaning machine learning is utilized to learn process behavior.

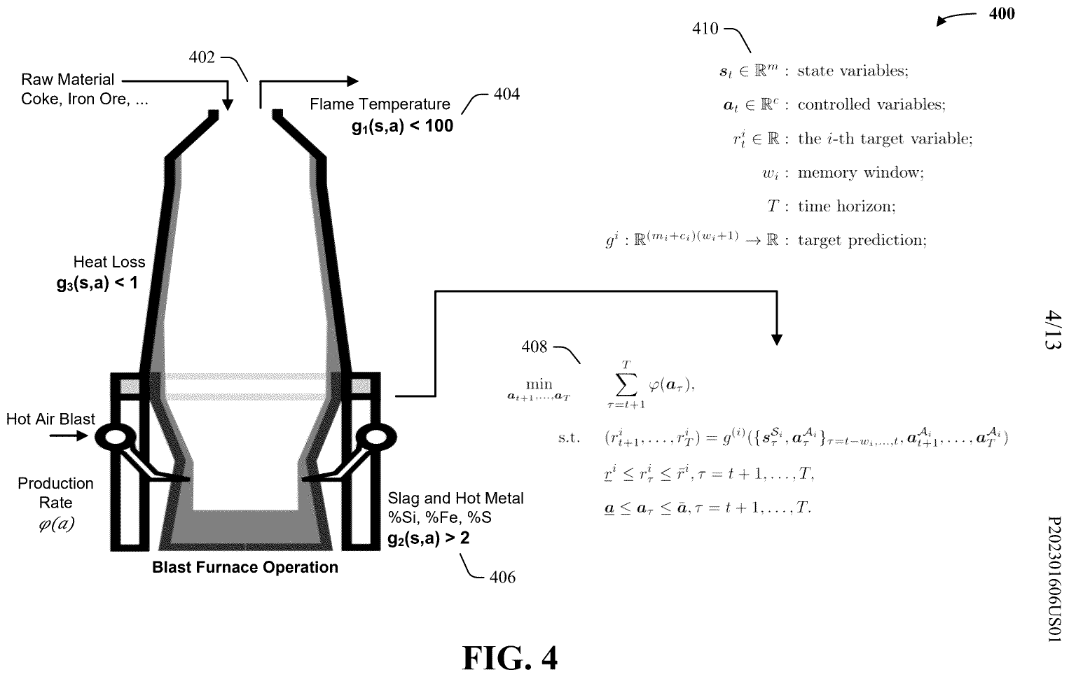

FIG. 4 illustrates an example, non-limiting representation of process set-point recommendation in accordance with one or more embodiments described herein.

As previously stated, a machine learning model is utilized to learn the behavior of a process, meaning target KPIs can be predicted from provided candidate set-points. For example, quality can be monitored in different areas of a process to maintain a set of KPIs within determined limits or in compliance with constraints. Historical data on control variables x can be used in the state-based action response model (e.g., data-driven surrogate model), which is automatically learned, to obtain an optimal solution for x that optimizes a response variable y. As an example, depicted by 402, a process can have control variables for temperature and silica percentage in a blast furnace. The process can have temperature constraints at 404 and silica percentage constraints at 406, wherein [symbol] ₁(s,a)<100 limits temperature and [symbol] ₂(s,a)>2 limits silica percentage. Such constraints and KPIs must be maintained given a set of set-points of x. Therefore, machine learning can be employed to learn KPIs (e.g., [symbol] ₁(s,a)) on the input set-point x, and the control problem can be solved by formulating it into an optimization problem 408 with parameters defined by 410. The optimization problem 408 is formulated to identify set-points (e.g., control variables) to predict target values (e.g., response variables) within respective defined ranges. In various aspects, the machine learning model can be defined by functions φ and [symbol] . In the methods described herein, functions φ and [symbol] are assumed to be generic forecasting models (e.g., NARX, TDCNN, Foundation models, ensemble models). Thus, these methods are not limited to linearizing simple models or a restricted class of AI models. Model linearization can be supported for a general class of AI and multivariate time series forecasting models that can then be integrated into optimization formulation.

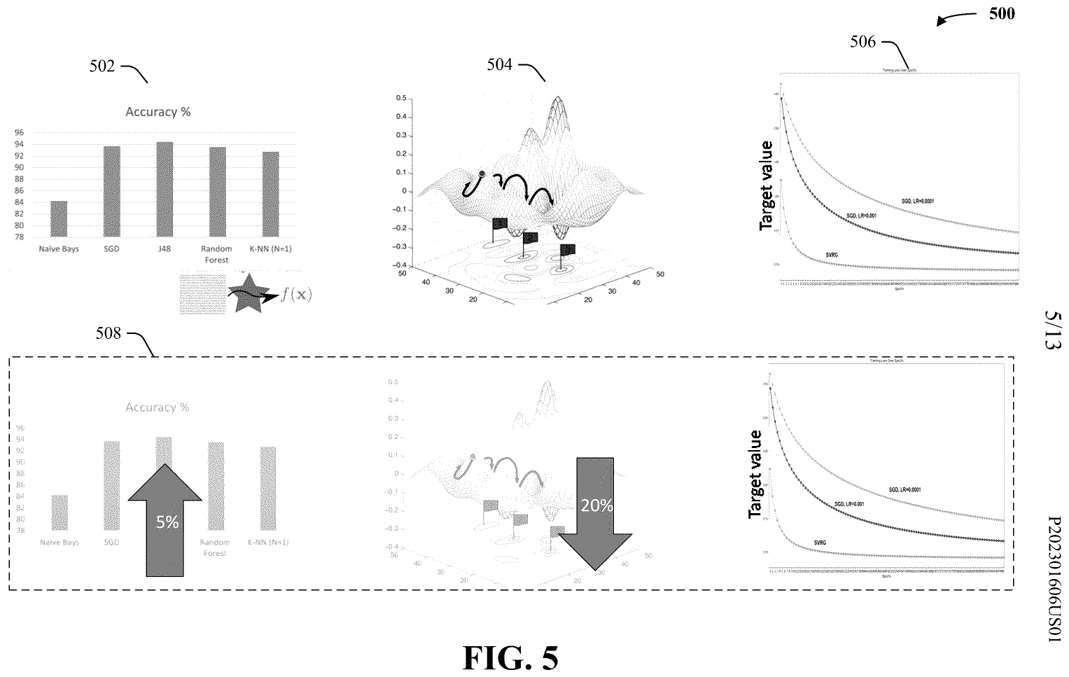

FIG. 5 illustrates an example, non-limiting representation of decision optimization pipelines in accordance with one or more embodiments described herein.

A decision optimization pipeline can be justified based on three coupled metrics. The three coupled metrics can comprise machine learning accuracy 502, optimization solution quality 504, and convergence rates 506. Machine learning accuracy can measure accuracy of the employed machine learning to learn the behavior of a KPI or process. Optimization solution quality measures the quality of the identified set-points. Furthermore, faster convergence rates are desired in decision optimization pipelines. For example, depicted by 508 is an example decision optimization pipeline's three coupled metrics. As shown, accuracy can be improved by 5%. However, in this example, the function can contain multiple local minima. Therefore, if the optimization problem is not solved in a particular manner, the identified set-point can be a local minima instead of a global minimum solution, causing a 20% decrease in accuracy. Thus, in assessing the three metrics, the set-points can be determined to be low quality. The methods described herein can mitigate such challenges by efficiently solving the optimization problem to ensure a global solution is obtained, providing a justified decision optimization pipeline.

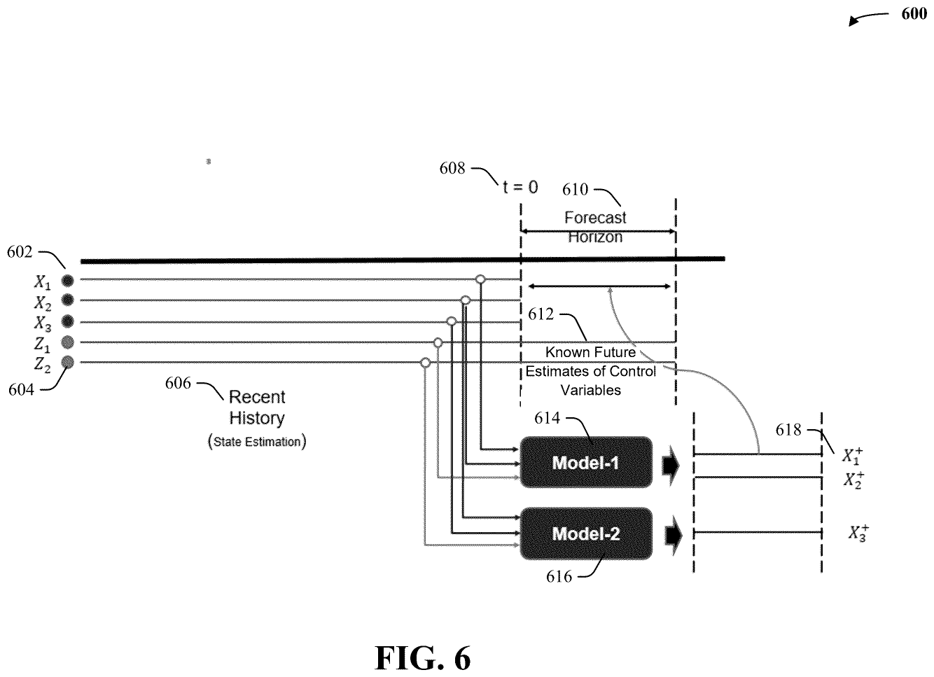

FIGS. 6-8 illustrate how the optimization problem can be solved to efficiently obtain a set-point recommendation. FIG. 6 illustrates an example, non-limiting representation of model setup for multivariate time series forecasting model training in accordance with one or more embodiments described herein.

Depicted in FIG. 6 are state variables 602 and control variables 604. In this example model setup, a physical system can be monitored by measurements of three state variables 602 (e.g., KPIs), denoted by X₁, X₂, and X₃, and two control variables 604, denoted by Z₁ and Z₂. Furthermore, state variables 602 and control variables 604 can comprise historical data 606. In various aspects, the historical data 606 can be time series data or tabular data of the state variables 602 and control variables 604. The historical data 606 can be obtained up to the current time 608 (e.g., t=0). Over a forecast horizon 610 (e.g., T), there can be future actions 612 (e.g., known future estimates of control variables). In various instances, the future actions 612 can be determined by an operator of the physical system or an optimization engine that determines future control variables for a determined amount of time (e.g., forecast horizon 610). Future control variables are able to be predetermined variables because the operator, for example, is able to manually control these variables. Thus, the prediction component 110 can predict future values of state variables 618 through one or more generic forecasting models. For example, model 614 can predict future values of state variables X₁ and X₂, denoted by X₁⁺ and X₂⁺, and model 616 can predict future values of state variable X₃, denoted by X₃⁺. In various aspects, the one or more generic forecasting models can utilize the historical data 606 along with future data of control variables Z₁⁺ and Z₂⁺ to compute a prediction of future values of state variables 618 over the forecast horizon. For example, the forecast horizon can be four hours, meaning the generic forecasting models can generate a forecast (e.g., action trajectory) over the next four hours. More generally, one or more generic forecasting models can predict future state variables Xᵢ⁺ based on historical data of state variables Xᵢ⁻, historical data of control variables Zⱼ⁻, and future control variables Zⱼ⁺, wherein i and j index the state variables and control variables respectively, over the forecasting horizon. In various embodiments, the training component 108 can utilize the response from the forecasting model (e.g., the predicted future state variables 602) to train the state-based action response model.

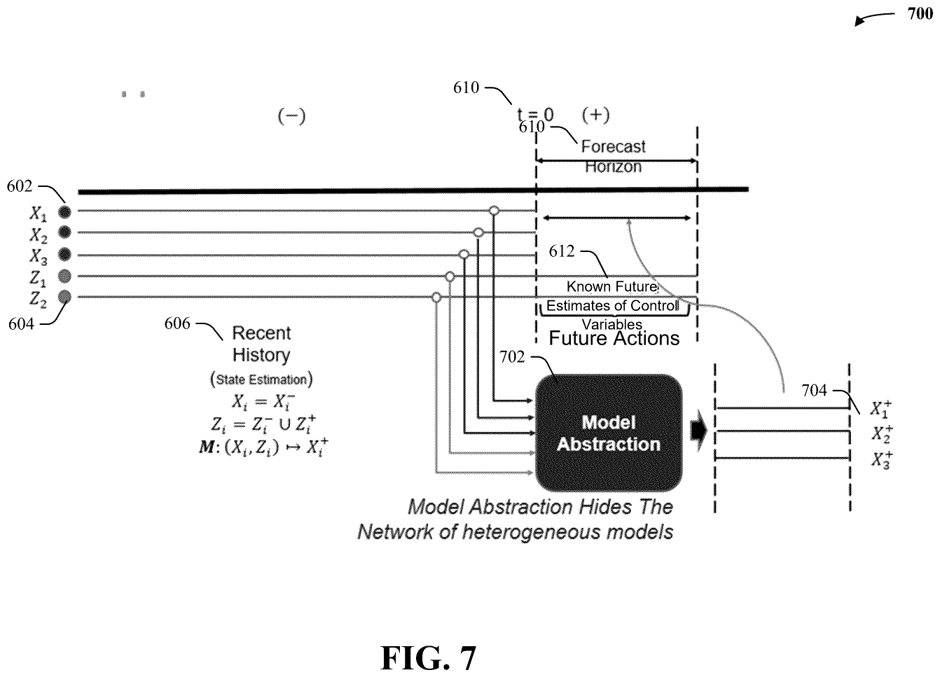

FIG. 7 illustrates an example, non-limiting representation of approximating forecasting models in accordance with one or more embodiments described herein.

Optimizing a generic forecasting model directly can be challenging as generic forecasting models are highly non-linear and non-convex. In various aspects, the state-based action response model can approximate the generic forecasting model instead, which the state-based action response model can then be linearized instead for process optimization. Model abstraction 702 can hide the network of heterogeneous models (e.g., model 614 and model 616) by using a global complex forecasting model. The global complex forecasting model for predicting future state variables X+, denoted by M, can be defined by M:(Xᵢ,Zᵢ)→Xᵢ⁺, where Xᵢ=Xᵢ⁻ and Zᵢ=Zᵢ⁻∪Zᵢ⁺. In various aspects, the global complex forecasting model M can map historical values of state variables, historical values of control variables, and future values of control variables to future values of state variables. For example, model M maps Xᵢ and Zᵢ to X₁⁺, X₂⁺, and X₃⁺, as depicted by 704. In various embodiments, the training component 108 can utilize the response of the global complex forecasting model as a target trajectory to train the state-based action response model.

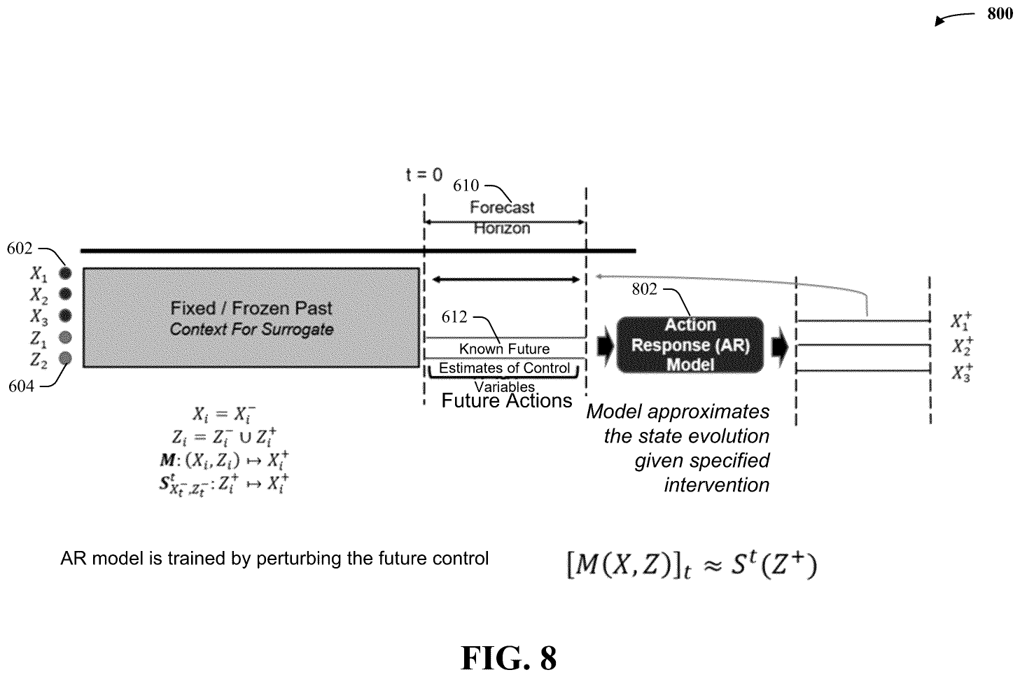

FIG. 8 illustrates an example, non-limiting representation of approximating forecasting models in accordance with one or more embodiments described herein.

In various embodiments, the training component 108 can train the state-based action response model 802 by perturbing future control variables. Thus, the state-based action response model 802 is not only trained to forecast on historical data like the global complex forecasting model. The state-based action response model 802 is further trained on future action (e.g., Zᵢ⁺) to predict output of the global complex forecasting model by mapping Zᵢ⁺ to Xᵢ⁺. Then, the state-based action response model 802 can approximate the state evolution given specified intervention. In various aspects, the action response model 802 can be structured as an optimization framework by the following functions:

$$M : ( {X}_{i} , {Z}_{i} ) ↦ {X}_{i}^{+} , {S}_{{X}_{t}^{-} , {Z}_{t}^{-}}^{t} : {Z}_{i}^{+} ↦ {X}_{i}^{+}$$

where Zᵢ=Zᵢ⁻∪Zᵢ⁺ and Xᵢ=Xᵢ⁻. As previously described, M represents the global complex model and is a function of future control (e.g., action) variables, past control variables, and past state variables. S^{t}, the state-based action response model 802, represents an optimization task that approximates M, and is only a function of future control variables (e.g., future actions). As an example, S^{t} can use linearization to approximate M. Thus, the action response model 802 can be formulated by [M(X,Z)]ₜ≈S^{t}(Z⁺). Therefore, the state-based action response model 802 can compute trajectory approximations of the long-horizon action trajectories over the forecasting horizon. The analysis component 112 can then linearize the state-based action response model 802 and perform optimization over the state-based action response model 802 to obtain a set-point recommendation.

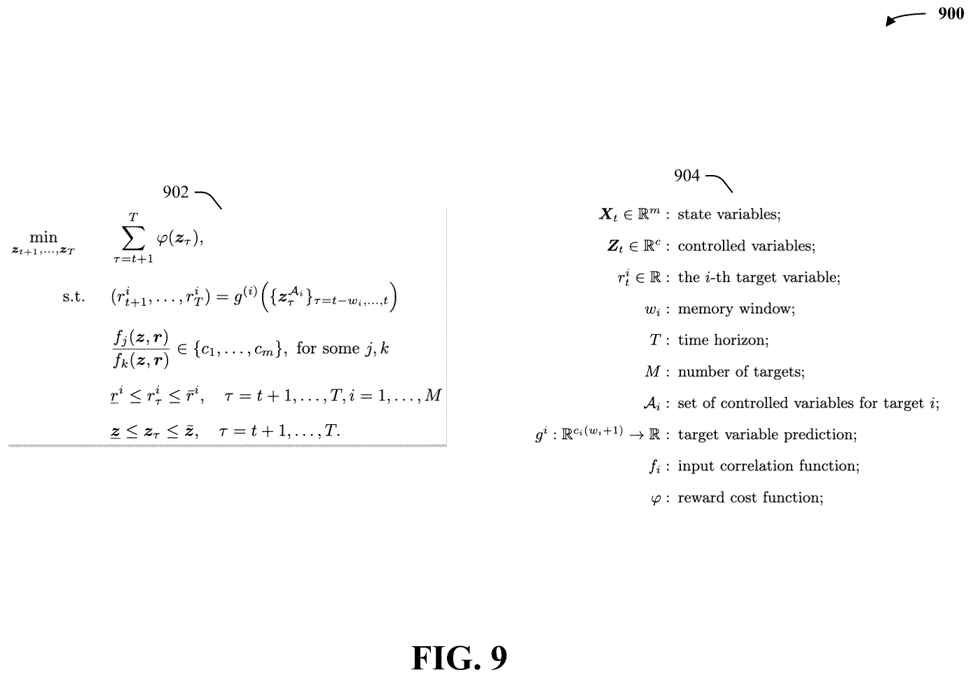

FIG. 9 illustrates an example, non-limiting representation of an optimization model for set-point recommendation in accordance with one or more embodiments described herein.

In various embodiments, the state-based action response model can be reformulated as an optimization problem that can be solved to obtain a set-point recommendation. More specifically, the analysis component 112 can linearize the state-based action response model to enable a globally optimal solution to be obtained efficiently. In various aspects, the state-based action response model can be linearized by Equation 1, as shown by 902.

$${min}_{{z}_{t + 1} , … , {z}_{T}} {\sum }_{τ = t + 1}^{T} φ ( {z}_{τ} ) , \qquad Equation 1$$

$$( {r}_{t}^{i} , … , {r}_{T}^{i} ) = {g}^{( i )} ( {\{ {z}_{τ}^{{A}_{i}} \}}_{τ = t - {w}_{i} , … , t} )$$

$$\frac{{f}_{j} ( z , r )}{{f}_{k} ( z , r )} ∈ \{ {c}_{1} , … , {c}_{m} \} , for some j , k$$

$${\underline{r}}^{i} \leq {r}_{τ}^{i} \leq {\overline{r}}^{i} , τ = t + 1 , … , T , i = 1 , … , M$$

$$\underline{z} \leq {z}_{τ} \leq \overline{z} , τ = t + 1 , … , T ,$$

where Xₜ∈ [symbol] ^{m} represents state variables, Zₜ∈ [symbol] ^{c} represents controlled variables, rₜⁱ∈ [symbol] denotes the i-th target variable, wᵢ denotes a memory window, T represents a time horizon, M defines the number of targets, Aᵢ denotes the set of controlled variable for target i, gᵢ: [symbol] ^{c}^{ᵢ}^{(w}^{ₜ}⁺¹⁾→ [symbol] denotes a target variable prediction, ƒᵢ represents an input correlation function, and φ defines a reward cost function, as shown by 904. Furthermore, r and z represent lower bounds, and r̅, z̅ denote upper bounds. In various aspects, linearization of the state-based action response model can also incorporate business rules or input constraints. Such a constraint on a process can be a ratio wherein the ratio between two parameters must remain within a limited set of values. For example, in Equation 1, there is a constraint that limits, for a ratio of an input correlation function, the values of ƒⱼ/ƒₖ. More specifically, ƒⱼ/ƒₖ is bound by the pre-defined values {c₁, . . . , cₘ}.

In various embodiments, the training component 108 can linearize such side constraints or business rules (e.g., ƒⱼ/ƒₖ) on correlated control variables with piece-wise linear models. Linearizing constraints can efficiently enable compliance with business requirements or operation constraints. In the case of a limited option constraint, the training component 108 can use a piece-wise linear representation for an input correlation function ƒᵢ(x). An additional variable vi can be employed to represent vᵢ=ƒᵢ(x) as a set of linear constraints. For example, for the limited option constraint vᵢ/vₖ∈{c₁, . . . , cₘ}, the training component 108 can linearize the constraint by the following piece-wise linear model.

$${u}_{l}^{k} \geq 0 , l = 1 , … , m$$

$${u}_{l}^{k} \leq {z}_{l}^{k} , {z}_{l}^{k} ∈ \{ 0 , 1 \}$$

$${u}_{l}^{k} \geq {v}_{k} - ( 1 - {z}_{l}^{k} )$$

$${u}_{l}^{k} \leq {v}_{k} - ( 1 + {z}_{l}^{k} )$$

$${v}_{i} = {\sum }_{l = 1}^{m} {c}_{i} {u}_{l}^{k} , {\sum }_{l = 1}^{m} {z}_{l}^{k} = 1 .$$

For a bound constraint

$$l b \leq \frac{{v}_{i}}{{v}_{k}} \leq u b ,$$

a multilayer perceptron representation for

$$y = \frac{{v}_{i}}{{v}_{k}}$$

as a MILP can be utilized. Therefore, the bound can be enforced on y as lb≤y≤ub.

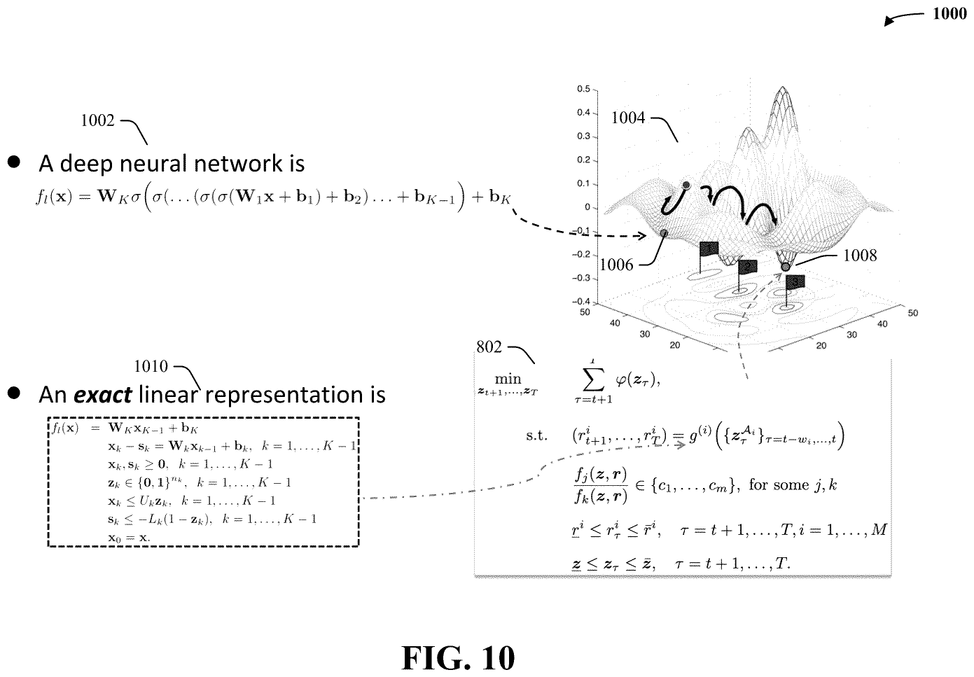

FIG. 10 illustrates an example, non-limiting representation of reformulation to mixed-integer linear programming in accordance with one or more embodiments described herein.

In various embodiments, the encoding component 114 can reformulate the state-based action response model as a MILP, as depicted by FIG. 9. MILP can be employed to mitigate obtaining solutions that are local minimum instead of a global minimum. For example, illustrated in 1004 are multiple local minima, which can cause a machine learning model to obtain a local minima solution 1006 instead of a global solution 1008. As shown by 1002, a deep neural network with K layers can be defined by Equation 2.

$${f}_{l} ( x ) = {W}_{K} σ ( σ ( … ( σ ( σ ( {W}_{1} x + {b}_{1} ) + {b}_{2} ) … + {b}_{K} - 1 ) + {b}_{K} , \qquad Equation 2$$

where Wᵢ is the weight matrix, bᵢ is the bias, and σ is an activation function

Furthermore, an exact linear representation 1008 of Equation 2 can be defined by Equation 3.

$${f}_{l} ( x ) = {W}_{K} {x}_{K - 1} + {b}_{K} \qquad Equation 3$$

$${x}_{k} - {s}_{k} = {W}_{k} {x}_{k - 1} + {b}_{k} , k = 1 , … , K - 1$$

$${x}_{k} , {s}_{k} \geq 0 , k = 1 , … , K - 1$$

$${z}_{k} ∈ {\{ 0 , 1 \}}^{{n}_{k}} , k = 1 , … , K - 1$$

$${x}_{k} \leq {U}_{k} {z}_{k} , k = 1 , … , K - 1$$

$${s}_{k} \leq - {L}_{k} ( 1 - {z}_{k} ) , k = 1 , … , K - 1$$

$${x}_{0} = x .$$

where nₖ is the number of neurons at the k-th layer, Uₖ and Lₖ are big constant numbers, xₖ, sₖ, zₖ are additional variables.

The linear representation 1010 is equivalent to the deep learning neural network definition but can allow the model to rely on linear programming to escape the local minima and obtain the global solution 1008. The state-based action response model (e.g., [symbol] ⁽ⁱ⁾) in optimization formulation 902 can be formulated by the defined deep learning neural network, however the deep learning neural network can be a non-linear function. Therefore, the equivalent linear representation 1010 can be employed to enable efficient solving of the optimization problem to obtain set-point recommendations.

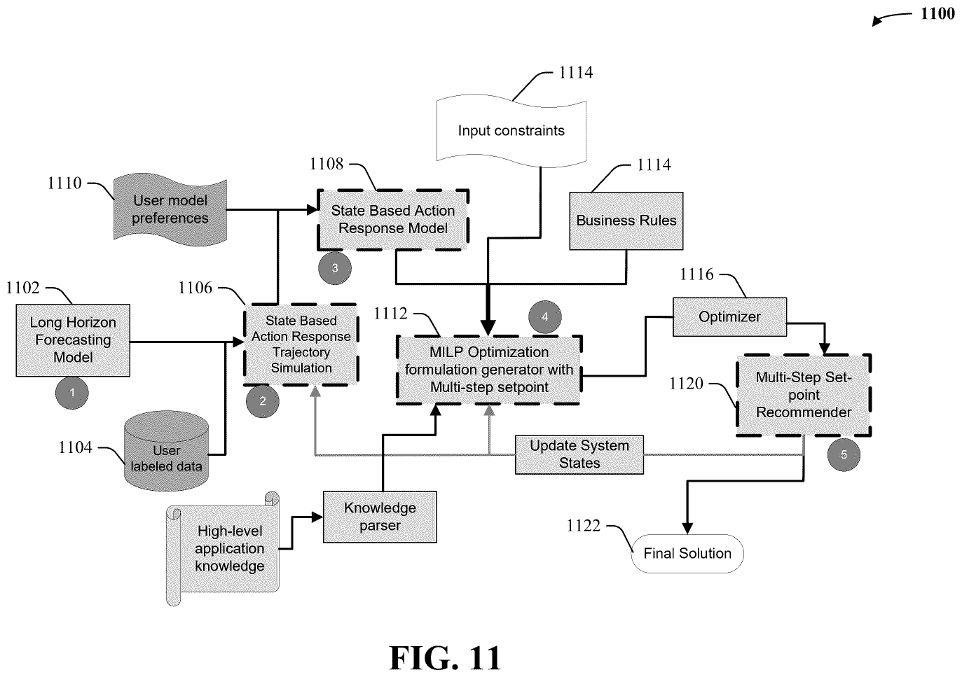

FIG. 11 illustrates an example, non-limiting representation of a system architecture 1100 that can facilitate automated control for a physical system with generic forecasting models in accordance with one or more embodiments described herein.

In various embodiments, the system architecture 1100 can comprise a long horizon forecasting model 1102. The long horizon forecasting model 1102 can be trained by the training component 108 using user labeled data 1104 (e.g., historical tabular or time series data). In various aspects, the prediction component 110 can then perform state-based action trajectory simulation 1106. The simulated action trajectories can be used as target trajectories to train a state-based action response model 1108. The state-based action response model 1108 can further incorporate user model preferences 1110. In various cases, the encoding component 114 can reformulate the state-based action response model 1108 as a MILP optimization problem. In other words, the encoding component 114 can employ a MILP optimization formulation generator with multi-step setpoint 1112 for the state-based action response model 1108. Moreover, the MILP optimization formulation generator with multi-step setpoint 1112 can include input constraints or business rules 1114 into optimization formulation. Thus, the analysis component 112 can employ an optimizer 1116 in a multi-step set-point recommender 1120 to obtain a final solution 1122 (e.g., a multi-step set-point recommendation). Furthermore, the multi-step set-point recommender 1120 can update system states in state-based action trajectory simulation 1106 and MILP optimization formulation generator with multi-step setpoint 1112.

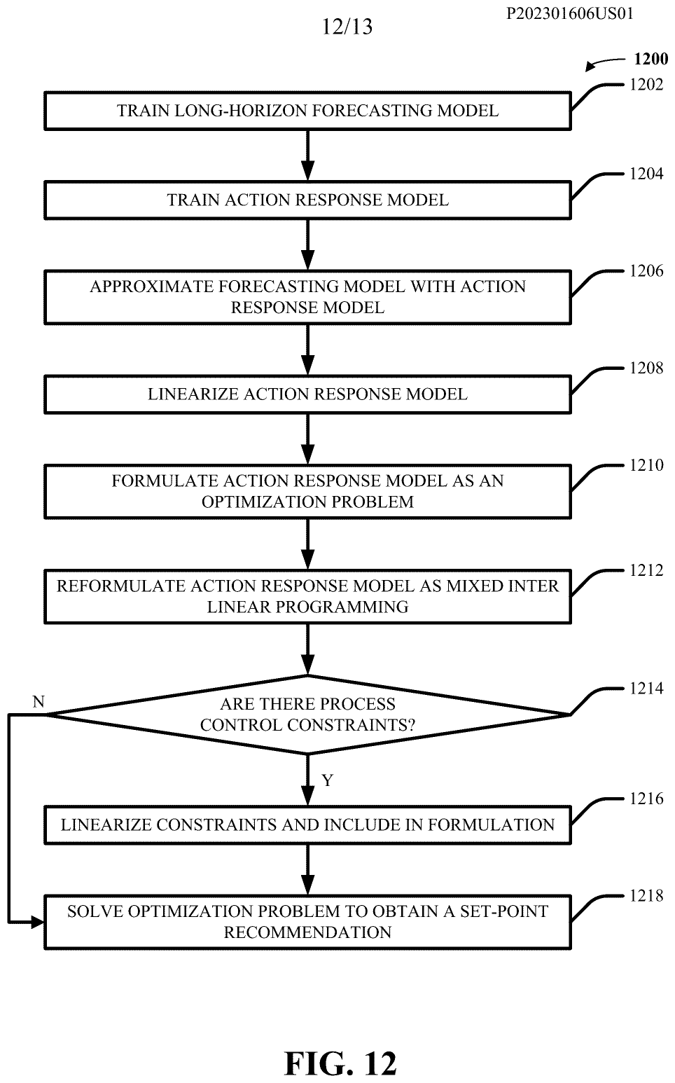

FIG. 12 illustrates a flow diagram of an example, non-limiting method 1200 of facilitating automated control for a physical system with generic forecasting models in accordance with one or more embodiments described herein.

At 1202, the non-limiting method 1200 can comprise learning (e.g., by the training component 108), by the system, a long-horizon forecasting model.

At 1204, the non-limiting method 1200 can comprise training (e.g., by the training component 108), by the system, an action response model.

At 1206, the non-limiting method 1200 can comprise approximating (e.g., by the training component 108), by the system, the forecasting model with the action response model.

At 1208, the non-limiting method 1200 can comprise linearizing (e.g., by the analysis component 112), by the system, the action response model.

At 1210, the non-limiting method 1200 can comprise formulating (e.g., by the analysis component 112), by the system, the action response model as an optimization problem.

At 1212, the non-limiting method 1200 can comprise reformulating (e.g., by the encoding component 114), by the system, the action response model as mixed integer linear programming.

At 1214, the non-limiting method 1200 can determine if there are process control constraints. If yes (e.g., there are process control constraints), the non-limiting method 1200 can proceed to 1216. If no (e.g., there are no process control constraints), the non-limiting method 1200 can proceed to 1218.

At 1216, the non-limiting method 1200 can comprise linearizing (e.g., by the training component 108), by the system, constraints and including the linearized constraints in the formulation.

At 1218, the non-limiting method 1200 can comprise solving (e.g., by the analysis component 112), by the system, the optimization problem to obtain a set-point recommendation.

For simplicity of explanation, the computer-implemented and non-computer-implemented methodologies provided herein are depicted and/or described as a series of acts. It is to be understood that the subject innovation is not limited by the acts illustrated and/or by the order of acts, for example acts can occur in one or more orders and/or concurrently, and with other acts not presented and described herein. Furthermore, not all illustrated acts can be utilized to implement the computer-implemented and non-computer-implemented methodologies in accordance with the described subject matter. Additionally, the computer-implemented methodologies described hereinafter and throughout this specification are capable of being stored on an article of manufacture to enable transporting and transferring the computer-implemented methodologies to computers. The term article of manufacture, as used herein, is intended to encompass a computer program accessible from any computer-readable device or storage media.

The systems and/or devices have been (and/or will be further) described herein with respect to interaction between one or more components. Such systems and/or components can include those components or sub-components specified therein, one or more of the specified components and/or sub-components, and/or additional components. Sub-components can be implemented as components communicatively coupled to other components rather than included within parent components. One or more components and/or sub-components can be combined into a single component providing aggregate functionality. The components can interact with one or more other components not specifically described herein for the sake of brevity, but known by those of skill in the art.

One or more embodiments described herein can employ hardware and/or software to solve problems that are highly technical, that are not abstract, and that cannot be performed as a set of mental acts by a human. For example, a human, or even thousands of humans, cannot efficiently, accurately and/or effectively perform machine learning for learning process behavior as the one or more embodiments described herein can enable this process. And, neither can the human mind nor a human with pen and paper perform automated control for a physical system with generic forecasting models, as conducted by one or more embodiments described herein.

FIG. 13 illustrates a block diagram of an example, non-limiting, operating environment in which one or more embodiments described herein can be facilitated. FIG. 13 and the following discussion are intended to provide a general description of a suitable operating environment 1300 in which one or more embodiments described herein at FIGS. 1-9 can be implemented.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 1300 contains an example of an environment for the execution of at least some of the computer code involved in performing the inventive methods, such as action trajectory generation code 1345. In addition to block 1345, computing environment 1300 includes, for example, computer 1301, wide area network (WAN) 1302, end user device (EUD) 1303, remote server 1304, public cloud 1305, and private cloud 1306. In this embodiment, computer 1301 includes processor set 1310 (including processing circuitry 1320 and cache 1321), communication fabric 1311, volatile memory 1312, persistent storage 1313 (including operating system 1322 and block 1345, as identified above), peripheral device set 1314 (including user interface (UI), device set 1323, storage 1324, and Internet of Things (IoT) sensor set 1325), and network module 1315. Remote server 1304 includes remote database 1330. Public cloud 1305 includes gateway 1340, cloud orchestration module 1341, host physical machine set 1342, virtual machine set 1343, and container set 1344.

COMPUTER 1301 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 1330. As is well understood in the art of computer technology, and depending upon the technology, performance of a computer-implemented method may be distributed among multiple computers and/or between multiple locations. On the other hand, in this presentation of computing environment 1300, detailed discussion is focused on a single computer, specifically computer 1301, to keep the presentation as simple as possible. Computer 1301 may be located in a cloud, even though it is not shown in a cloud in FIG. 12. On the other hand, computer 1301 is not required to be in a cloud except to any extent as may be affirmatively indicated.

PROCESSOR SET 1310 includes one, or more, computer processors of any type now known or to be developed in the future. Processing circuitry 1320 may be distributed over multiple packages, for example, multiple, coordinated integrated circuit chips. Processing circuitry 1320 may implement multiple processor threads and/or multiple processor cores. Cache 1321 is memory that is located in the processor chip package(s) and is typically used for data or code that should be available for rapid access by the threads or cores running on processor set 1310. Cache memories are typically organized into multiple levels depending upon relative proximity to the processing circuitry. Alternatively, some, or all, of the cache for the processor set may be located “off chip.” In some computing environments, processor set 1310 may be designed for working with qubits and performing quantum computing.

Computer readable program instructions are typically loaded onto computer 1301 to cause a series of operational steps to be performed by processor set 1310 of computer 1301 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 1321 and the other storage media discussed below. The program instructions, and associated data, are accessed by processor set 1310 to control and direct performance of the inventive methods. In computing environment 1300, at least some of the instructions for performing the inventive methods may be stored in block 1345 in persistent storage 1313.

COMMUNICATION FABRIC 1311 is the signal conduction paths that allow the various components of computer 1301 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 1312 is any type of volatile memory now known or to be developed in the future. Examples include dynamic type random access memory (RAM) or static type RAM. Typically, the volatile memory is characterized by random access, but this is not required unless affirmatively indicated. In computer 1301, the volatile memory 1312 is located in a single package and is internal to computer 1301, but, alternatively or additionally, the volatile memory may be distributed over multiple packages and/or located externally with respect to computer 1301.

PERSISTENT STORAGE 1313 is any form of non-volatile storage for computers that is now known or to be developed in the future. The non-volatility of this storage means that the stored data is maintained regardless of whether power is being supplied to computer 1301 and/or directly to persistent storage 1313. Persistent storage 1313 may be a read only memory (ROM), but typically at least a portion of the persistent storage allows writing of data, deletion of data and re-writing of data. Some familiar forms of persistent storage include magnetic disks and solid state storage devices. Operating system 1322 may take several forms, such as various known proprietary operating systems or open source Portable Operating System Interface type operating systems that employ a kernel. The code included in block 1345 typically includes at least some of the computer code involved in performing the inventive methods.

PERIPHERAL DEVICE SET 1314 includes the set of peripheral devices of computer 1301. Data communication connections between the peripheral devices and the other components of computer 1301 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 1323 may include components such as a display screen, speaker, microphone, wearable devices (such as goggles and smart watches), keyboard, mouse, printer, touchpad, game controllers, and haptic devices. Storage 1324 is external storage, such as an external hard drive, or insertable storage, such as an SD card. Storage 1324 may be persistent and/or volatile. In some embodiments, storage 1324 may take the form of a quantum computing storage device for storing data in the form of qubits. In embodiments where computer 1301 is required to have a large amount of storage (for example, where computer 1301 locally stores and manages a large database) then this storage may be provided by peripheral storage devices designed for storing very large amounts of data, such as a storage area network (SAN) that is shared by multiple, geographically distributed computers. IoT sensor set 1325 is made up of sensors that can be used in Internet of Things applications. For example, one sensor may be a thermometer and another sensor may be a motion detector.

NETWORK MODULE 1315 is the collection of computer software, hardware, and firmware that allows computer 1301 to communicate with other computers through WAN 1302. Network module 1315 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 1315 are performed on the same physical hardware device. In other embodiments (for example, embodiments that utilize software-defined networking (SDN)), the control functions and the forwarding functions of network module 1315 are performed on physically separate devices, such that the control functions manage several different network hardware devices. Computer readable program instructions for performing the inventive methods can typically be downloaded to computer 1301 from an external computer or external storage device through a network adapter card or network interface included in network module 1315.

WAN 1302 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 1303 is any computer system that is used and controlled by an end user (for example, a customer of an enterprise that operates computer 1301), and may take any of the forms discussed above in connection with computer 1301. EUD 1303 typically receives helpful and useful data from the operations of computer 1301. For example, in a hypothetical case where computer 1301 is designed to provide a recommendation to an end user, this recommendation would typically be communicated from network module 1315 of computer 1301 through WAN 1302 to EUD 1303. In this way, EUD 1303 can display, or otherwise present, the recommendation to an end user. In some embodiments, EUD 1303 may be a client device, such as thin client, heavy client, mainframe computer, desktop computer and so on.

REMOTE SERVER 1304 is any computer system that serves at least some data and/or functionality to computer 1301. Remote server 1304 may be controlled and used by the same entity that operates computer 1301. Remote server 1304 represents the machine(s) that collect and store helpful and useful data for use by other computers, such as computer 1301. For example, in a hypothetical case where computer 1301 is designed and programmed to provide a recommendation based on historical data, then this historical data may be provided to computer 1301 from remote database 1330 of remote server 1304.

PUBLIC CLOUD 1305 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 1305 is performed by the computer hardware and/or software of cloud orchestration module 1341. The computing resources provided by public cloud 1305 are typically implemented by virtual computing environments that run on various computers making up the computers of host physical machine set 1342, which is the universe of physical computers in and/or available to public cloud 1305. The virtual computing environments (VCEs) typically take the form of virtual machines from virtual machine set 1343 and/or containers from container set 1344. It is understood that these VCEs may be stored as images and may be transferred among and between the various physical machine hosts, either as images or after instantiation of the VCE. Cloud orchestration module 1341 manages the transfer and storage of images, deploys new instantiations of VCEs and manages active instantiations of VCE deployments. Gateway 1340 is the collection of computer software, hardware, and firmware that allows public cloud 1305 to communicate through WAN 1302.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 1306 is similar to public cloud 1305, except that the computing resources are only available for use by a single enterprise. While private cloud 1306 is depicted as being in communication with WAN 1302, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 1305 and private cloud 1306 are both part of a larger hybrid cloud.

The embodiments described herein can be directed to one or more of a system, a method, an apparatus and/or a computer program product at any possible technical detail level of integration. The computer program product can include a computer readable storage medium (or media) having computer readable program instructions thereon for causing a processor to carry out aspects of the one or more embodiments described herein. The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a superconducting storage device and/or any suitable combination of the foregoing. A non-exhaustive list of more specific examples of the computer readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon and/or any suitable combination of the foregoing. A computer readable storage medium, as used herein, is not to be construed as being transitory signals per se, such as radio waves and/or other freely propagating electromagnetic waves, electromagnetic waves propagating through a waveguide and/or other transmission media (e.g., light pulses passing through a fiber-optic cable), and/or electrical signals transmitted through a wire.

Computer readable program instructions described herein can be downloaded to respective computing/processing devices from a computer readable storage medium and/or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of the one or more embodiments described herein can be assembler instructions, instruction-set-architecture (ISA) instructions, machine instructions, machine dependent instructions, microcode, firmware instructions, state-setting data, configuration data for integrated circuitry, and/or source code and/or object code written in any combination of one or more programming languages, including an object oriented programming language such as Smalltalk, C++ or the like, and/or procedural programming languages, such as the “C” programming language and/or similar programming languages. The computer readable program instructions can execute entirely on a computer, partly on a computer, as a stand-alone software package, partly on a computer and/or partly on a remote computer or entirely on the remote computer and/or server. In the latter scenario, the remote computer can be connected to a computer through any type of network, including a local area network (LAN) and/or a wide area network (WAN), and/or the connection can be made to an external computer (for example, through the Internet using an Internet Service Provider). In one or more embodiments, electronic circuitry including, for example, programmable logic circuitry, field-programmable gate arrays (FPGA) and/or programmable logic arrays (PLA) can execute the computer readable program instructions by utilizing state information of the computer readable program instructions to personalize the electronic circuitry, in order to perform aspects of the one or more embodiments described herein.

Aspects of the one or more embodiments described herein are described with reference to flowchart illustrations and/or block diagrams of methods, apparatus (systems), and computer program products according to one or more embodiments described herein. It will be understood that each block of the flowchart illustrations and/or block diagrams, and combinations of blocks in the flowchart illustrations and/or block diagrams, can be implemented by computer readable program instructions. These computer readable program instructions can be provided to a processor of a general-purpose computer, special purpose computer and/or other programmable data processing apparatus to produce a machine, such that the instructions, which execute via the processor of the computer or other programmable data processing apparatus, can create means for implementing the functions/acts specified in the flowchart and/or block diagram block or blocks. These computer readable program instructions can also be stored in a computer readable storage medium that can direct a computer, a programmable data processing apparatus and/or other devices to function in a particular manner, such that the computer readable storage medium having instructions stored therein can comprise an article of manufacture including instructions which can implement aspects of the function/act specified in the flowchart and/or block diagram block or blocks. The computer readable program instructions can also be loaded onto a computer, other programmable data processing apparatus and/or other device to cause a series of operational acts to be performed on the computer, other programmable apparatus and/or other device to produce a computer implemented process, such that the instructions which execute on the computer, other programmable apparatus and/or other device implement the functions/acts specified in the flowchart and/or block diagram block or blocks.

The flowcharts and block diagrams in the figures illustrate the architecture, functionality and/or operation of possible implementations of systems, computer-implementable methods and/or computer program products according to one or more embodiments described herein. In this regard, each block in the flowchart or block diagrams can represent a module, segment and/or portion of instructions, which comprises one or more executable instructions for implementing the specified logical function. In one or more alternative implementations, the functions noted in the blocks can occur out of the order noted in the Figures. For example, two blocks shown in succession can be executed substantially concurrently, and/or the blocks can sometimes be executed in the reverse order, depending upon the functionality involved. It will also be noted that each block of the block diagrams and/or flowchart illustration, and/or combinations of blocks in the block diagrams and/or flowchart illustration, can be implemented by special purpose hardware-based systems that can perform the specified functions and/or acts and/or carry out one or more combinations of special purpose hardware and/or computer instructions.

While the subject matter has been described above in the general context of computer-executable instructions of a computer program product that runs on a computer and/or computers, those skilled in the art will recognize that the one or more embodiments herein also can be implemented at least partially in parallel with one or more other program modules. Generally, program modules include routines, programs, components and/or data structures that perform particular tasks and/or implement particular abstract data types. Moreover, the afore described computer-implemented methods can be practiced with other computer system configurations, including single-processor and/or multiprocessor computer systems, mini-computing devices, mainframe computers, as well as computers, hand-held computing devices (e.g., PDA, phone), and/or microprocessor-based or programmable consumer and/or industrial electronics. The illustrated aspects can also be practiced in distributed computing environments in which tasks are performed by remote processing devices that are linked through a communications network. However, one or more, if not all aspects of the one or more embodiments described herein can be practiced on stand-alone computers. In a distributed computing environment, program modules can be located in both local and remote memory storage devices.

As used in this application, the terms “component,” “system,” “platform” and/or “interface” can refer to and/or can include a computer-related entity or an entity related to an operational machine with one or more specific functionalities. The entities described herein can be either hardware, a combination of hardware and software, software, or software in execution. For example, a component can be, but is not limited to being, a process running on a processor, a processor, an object, an executable, a thread of execution, a program and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system and/or across a network such as the Internet with other systems via the signal). As another example, a component can be an apparatus with specific functionality provided by mechanical parts operated by electric or electronic circuitry, which is operated by a software and/or firmware application executed by a processor. In such a case, the processor can be internal and/or external to the apparatus and can execute at least a part of the software and/or firmware application. As yet another example, a component can be an apparatus that provides specific functionality through electronic components without mechanical parts, where the electronic components can include a processor and/or other means to execute software and/or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form. As used herein, the terms “example” and/or “exemplary” are utilized to mean serving as an example, instance, or illustration. For the avoidance of doubt, the subject matter described herein is not limited by such examples. In addition, any aspect or design described herein as an “example” and/or “exemplary” is not necessarily to be construed as preferred or advantageous over other aspects or designs, nor is it meant to preclude equivalent exemplary structures and techniques known to those of ordinary skill in the art.

As it is employed in the subject specification, the term “processor” can refer to substantially any computing processing unit and/or device comprising, but not limited to, single-core processors; single-processors with software multithread execution capability; multi-core processors; multi-core processors with software multithread execution capability; multi-core processors with hardware multithread technology; parallel platforms; and/or parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, and/or any combination thereof designed to perform the functions described herein. Further, processors can exploit nano-scale architectures such as, but not limited to, molecular and quantum-dot based transistors, switches and/or gates, in order to optimize space usage and/or to enhance performance of related equipment. A processor can be implemented as a combination of computing processing units.

Herein, terms such as “store,” “storage,” “data store,” data storage,” “database,” and substantially any other information storage component relevant to operation and functionality of a component are utilized to refer to “memory components,” entities embodied in a “memory,” or components comprising a memory. Memory and/or memory components described herein can be either volatile memory or nonvolatile memory or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory and/or nonvolatile random-access memory (RAM) (e.g., ferroelectric RAM (FeRAM). Volatile memory can include RAM, which can act as external cache memory, for example. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM) and/or Rambus dynamic RAM (RDRAM). Additionally, the described memory components of systems and/or computer-implemented methods herein are intended to include, without being limited to including, these and/or any other suitable types of memory.

What has been described above includes mere examples of systems and computer-implemented methods. It is, of course, not possible to describe every conceivable combination of components and/or computer-implemented methods for purposes of describing the one or more embodiments, but one of ordinary skill in the art can recognize that many further combinations and/or permutations of the one or more embodiments are possible. Furthermore, to the extent that the terms “includes,” “has,” “possesses,” and the like are used in the detailed description, claims, appendices and/or drawings such terms are intended to be inclusive in a manner similar to the term “comprising” as “comprising” is interpreted when employed as a transitional word in a claim.

The descriptions of the various embodiments have been presented for purposes of illustration but are not intended to be exhaustive or limited to the embodiments described herein. Many modifications and variations will be apparent to those of ordinary skill in the art without departing from the scope and spirit of the described embodiments. The terminology used herein was chosen to best explain the principles of the embodiments, the practical application and/or technical improvement over technologies found in the marketplace, and/or to enable others of ordinary skill in the art to understand the embodiments described herein.

What is claimed is:

1. A system, comprising:
a processor that executes computer-executable components stored in a non-transitory computer-readable memory, the computer-executable components comprising:
a training component that trains one or more multivariate time series forecasting models; and
a prediction component that forecasts long-horizon action trajectories for a set of state variables over a defined range of time.

2. The system of claim 1, wherein the training component simulates action trajectories to obtain a response from a global forecasting model.

3. The system of claim 2, wherein the response from the global forecasting model is used as a target trajectory to train a state-based action response model.

4. The system of claim 3, further comprising an analysis component that linearizes the state-based action response model.

5. The system of claim 4, wherein the analysis component employs the state-based action response model to compute trajectory approximations of the long-horizon action trajectories.

6. The system of claim 1, wherein the training component linearizes constraints on correlated control variables with piece-wise linear equations.

7. The system of claim 3, further comprising an encoding component that reformulates the state-based action response model as a mixed-integer linear program.

8. The system of claim 7, wherein the prediction component employs the reformulated state-based action response model in optimization formulation to generate a multi-step set point recommendation.

9. The system of claim 3, wherein the training component trains the state-based action response model by perturbing future data on a set of control variables.

10. A computer-implemented method, comprising:
training, by the system, one or more multivariate time series forecasting models; and
forecasting, by the system, long-horizon action trajectories for a set of state variables over a defined range of time.

11. The computer-implemented method of claim 10, further comprising simulating action trajectories to obtain a response from a global forecasting model.

12. The computer-implemented method of claim 11, further comprising utilizing the response from the global forecasting model as a target trajectory to train a state-based action response model.

13. The computer-implemented method of claim 12, further comprising linearizing the state-based action response model.

14. The computer-implemented method of claim 13, further comprising employing the state-based action response model to compute trajectory approximations of the long-horizon action trajectories.

15. The computer-implemented method of claim 10, further comprising linearizing constraints on correlated control variables with piece-wise linear equations.

16. The computer-implemented method of claim 12, further comprising reformulating the state-based action response model as a mixed-integer linear program.

17. The computer-implemented method of claim 16, further comprising employing the reformulated state-based action response model in optimization formulation to generate a multi-step set point recommendation.

18. The computer-implemented method of claim 12, further comprising training the state-based action response model by perturbing future data on a set of control variables.

19. A computer program product comprising a non-transitory computer-readable memory having program instructions embodied therewith, the program instructions executable by a processor to cause the processor to:
train one or more multivariate time series forecasting models; and
forecast long-horizon action trajectories for a set of state variables over a defined range of time.

20. The computer program product of claim 19, wherein the program instructions are further executable to cause the processor to:
linearize constraints on correlated control variables with piece-wise linear equations.
